(19) United States
(12) Patent Application Publication
(10) Pub. No.: US 2003/0171048 A1
(43) Pub. Date: Sep. 11, 2003

(54) Layer structure

(76) Inventor: Stefan Stocker, Erlangen (DE)

Correspondence Address: SCHIFF HARDIN & WAITE, 6600 SEARS TOWER, 233 S WACKER DR, CHICAGO, IL, 60606-6473, US

(21) Appl. No.: 10/185,287

(22) Filed: Jun. 28, 2002

(30) Foreign Application Priority Data
Mar. 11, 2002 (DE) 20203908.0

(51) Int. Cl. B32B 17/04; B32B 27/38; D03D 15/00; B32B 3/00

(52) U.S. Cl. 442/175; 428/369; 428/180; 428/189; 428/203; 428/192

(57) ABSTRACT

A layer structure has at least two material layers with an intermediate or casting layer interposed between adjacent material layers. The intermediate layer includes a casting material and a plurality of elongated elements having different orientations which are extending across each other to form a weave to determine the interspacing between the two material layers before any casting material of the intermediate layer is inserted. The two material layers which are to be joined together may be gradient coils of a tomograph.

### BACKGROUND OF THE INVENTION

The present invention is directed to a layer structure which comprises at least two material layers which are connected together by a casting or intermediate layer interposed therebetween. The casting layer is arranged between the two material layers and is suited for connecting the two material layers to one another.

Layer structures of this type are known in the prior art. They are usually employed when material layers are to be durably connected to one another without the two material layers coming into direct contact with one another. In addition to the function of purely mechanical positioning of the material layers relative to one another, the casting layer arranged between the two material layers usually has at least one additional function, such as, for example, electrical insulation, thermal conduction, mechanical dampening and/or homogenization of a field.

Since the casting layer is formed by casting a material into a space between the two material layers, the material layers, which do not have smooth surfaces, can also be connected to one another via the casting layer.

In particular, such a layer structure is employed when joining gradient coils of a magnetic or nuclear magnetic resonance tomograph. Since the gradient switching times of the gradient coils of a tomograph should be as short as possible, current rise rates on an order of magnitude of 250 kA per second are needed. Due to this extremely strong magnetic field, which is present in the tomograph, strong mechanical vibrations of the coils are connected to such switching events due to the Lorenz force that occurs. It is therefore necessary to fix the gradient coils as well as possible relative to one another. Since the gradient coils are also loaded with high current, it is also necessary to eliminate the heat that occurs in the gradient coils. For this purpose, neighboring gradient coils are connected to one another via a casting layer. In addition to assuring the mechanical fixing of the gradient coils relative to one another, the casting layer must also assure both an electrical insulation of the gradient coils from one another as well as the elimination of heat that will occur in the gradient coils. Before the casting material is cast in, the gradient coils are to be exactly spatially arranged relative to one another and, for this reason, spacers are often introduced between the gradient coils. The known spacers are usually a matter of elongated elements having rectangular cross-section whose height corresponds to the desired spacing of the material layers to be connected.

What is disadvantageous of the known spacers is that a plurality of individual spacers must be introduced into the interspace between the two material layers to be connected that is to be cast out in order to dependently geometrically define the material layers relative to one another. It is thereby especially disadvantageous that the spacers are usually composed of different materials from the casting material and, thus, exhibit different physical properties. This can be particularly relevant in view of the thermal conductivity and/or the electrical insulation capabilities of the spacers. Another disadvantage in the employment of the known spacers is that the casting material, due to the essentially band-shaped seating surface of the spacers at the two material layers to be connected, frequently cannot fill out the entire interspace between the two material layers to be connected during the casting. Air bubbles are, thus, often enclosed in the casting layers. These enclosed air bubbles are a considerable disadvantage in view of the insulating strength and thermal conductivity of the casting layer. Given employment of a casting layer for connecting gradient coils of a tomograph, it must also be pointed out that air bubbles which are enclosed in the casting layer also lead to an inhomogeneity of the electrical field built up by the gradient coils, as a result whereof additional problems occur with respect to the insulation capabilities of the casting layer.

### SUMMARY OF THE INVENTION

An object of the present invention is to propose a layer structure having two material layers to be connected, wherein the two material layers to be connected can be fixed relative to one another with great precision and whereby adequate flow paths are provided for the casting material.

This object is achieved by a layer structure that has at least two material layers to be connected by a casting or intermediate layer, the casting layer is arranged between the two material layers and is suited for joining the two material layers to one another and the casting layer comprises a casting material and a plurality of elongated elements having different orientations, so that the elongated elements are crossed over each other to form a weave that determines a defined interspace between the two material layers before casting of the casting material between the two material layers.

As a result of providing mutually crossed, elongated elements with different orientations, it is possible, before the casting of the casting material, to define a specific interspace between the at least two material layers in a simple way. Since the elongated elements are crossed to form a weave, they only touch the material layers to be connected at small-area regions that are spaced from one another. In addition, the weave keeps a multitude of flow paths open for filling a casting material in, so that all regions of the interspace between the material layers can be filled up by the casting material.

Preferably, the weave extends over the entire casting layer. The interspace between the at least two material layers to be defined before the casting can, thus, first, be dependably set over the entire area of the interspace. In addition, the forces to be absorbed in the definition of the interspace (for example, weight of the material layers) is divided onto a plurality of elongated elements of the weave. Consequently, the forces to be absorbed by the individual elongated elements and the mechanical stresses at the elongated elements connected therewith are slight.

According to a preferred embodiment, the length of the elongated elements exceeds the height and width of the elongated elements by at least 20 times, so that the elongated elements are a matter of string-shaped and/or band-shaped elements.

The elongated elements can be manufactured in an especially simple way when they comprise a circular cross-section. Among other things advantageous about the circular cross-section, the contact surfaces of the elongated elements to the material layers to be connected can be reduced to very narrow surface strips. In addition, such elongated elements can be crossed to form a weave in an especially simple way with known weaving devices.

Alternatively, the elongated elements can also comprise an elliptical or polygonal cross-section.

According to a preferred embodiment, the weave formed by the elongated elements forms a plain weave, since optimally small contact areas of the elongated elements at the material layers to be joined can be achieved with such a weave.

When, in contrast, it is desirable that the contact surfaces of the elongated elements be increased at the individual material layers, the weave formed by the elongated elements can, alternatively, comprise a twill weave or an atlas weave. Fabrics having such weaves can be easily manufactured with traditional weaving methods.

It is especially advantageous when the weave formed by the elongated elements comprises a mesh width that produces a capillary effect with reference to a casting material. As a result of this mesh width, it can be assured that the interspace between the at least two material layers is completely filled up by the casting material in the region of the weave.

Due to the above-described advantages, the inventive layer structure is especially suited for utilization in nuclear magnetic or magnetic tomographs, whereby the two material layers, which are to be connected together, are gradient coils of the tomograph or, respectively, contain gradient coils of the tomographs, and the casting layer is arranged between the gradient coils.

Preferably, the elongated elements can be formed of HGW 2372 resin in a fiberglass union, and the casting material for the casting layer can contain epoxy resin. Specifications for the filament fiberglass fabric on the basis of epoxy resin, such as HGW 2372 resin, in a fiberglass union that exhibits excellent mechanical and electrical values and gives a very low dielectric loss factor are recited in DIN 7735 and in EN 60893.

Other advantages and features of the invention will be readily apparent from the following description of the preferred embodiments, the drawings and the claims.

### BACKGROUND OF THE INVENTION

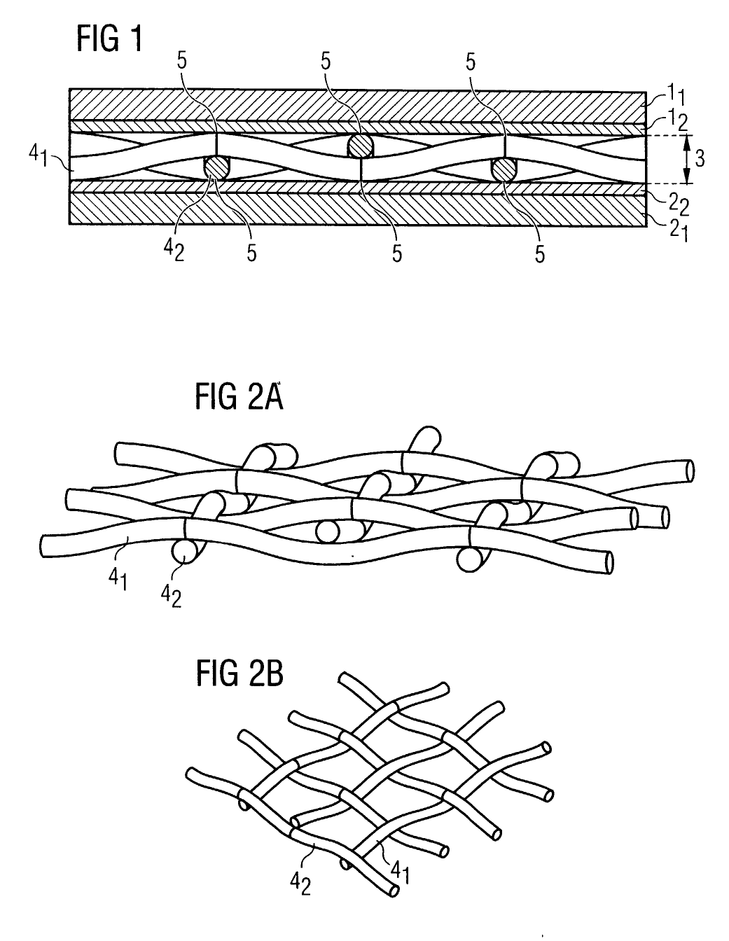

FIG. 1 is a cross-sectional view through the inventive layer structure;

FIG. 2A is a perspective view of a weave formed by the elongated element;

FIG. 2B is a second perspective view of the weave of FIG. 2A;

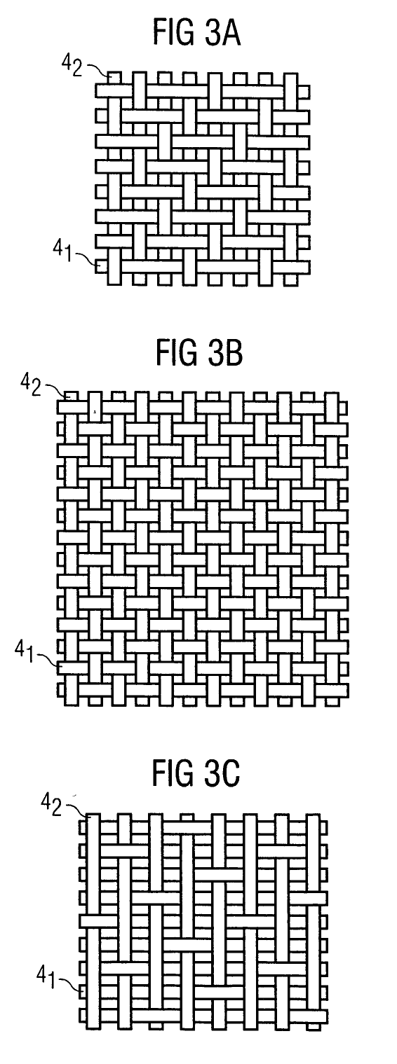

FIG. 3A is a plan view of a twill weave of the elongated elements;

FIG. 3B is a plan view of the simple weave of the elongated elements of FIGS. 2A and 2B;

FIG. 3C is a plan view of an atlas weave of the elongated elements;

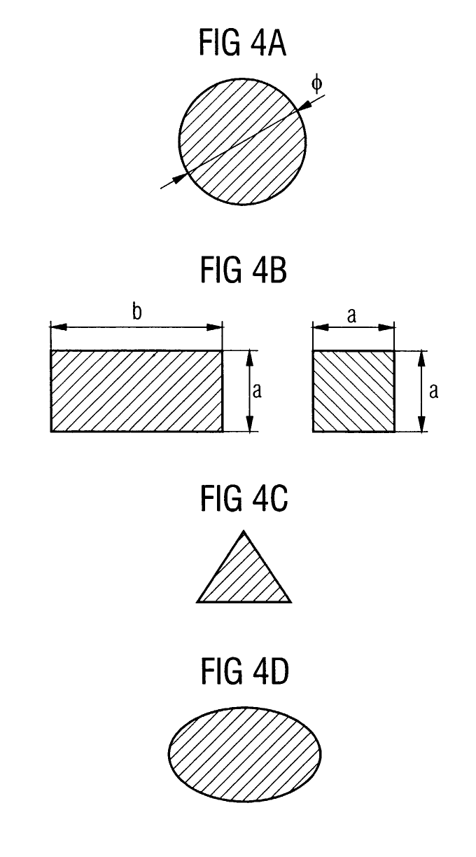

FIG. 4A is a cross-sectional view of the elongated element having a circular cross-section;

FIG. 4B is a cross-sectional view of the elongated element having a quadratic or rectangular cross-section and a square cross-section;

FIG. 4C is a cross-sectional view of the elongated element having a triangular cross-section; and

FIG. 4D is a cross-sectional view of the elongated element having an oval or elliptical cross-section.

### DESCRIPTION OF THE PREFERRED EMBODIMENTS

The principles of the present invention are useful in a layer structure illustrated in FIG. 1. The layer structure in FIG. 1 comprises two material layers 1₁ and 2₁, which are joined together by a casting or intermediate layer 3. The intermediate layer is arranged between the two layers 1₁ and 2₁ and is suited for durably connecting the two material layers 1₁ and 2₁ after the introduction of the casting material. In order to achieve a very good adhesion of the casting material, which is not shown in FIG. 1, to the material layers 1₁ and 2₁ which are to be connected, a respective bonding layer 1₂ and 2₂ is applied to the two material layers 1₁ and 2₁, which are to be joined together. According to the present invention, the intermediate layer 3 comprises a plurality of elongated elements 4₁ and 4₂ having different orientations, whereby the elongated elements 4₁ and 4₂ are crossed over each other to form a weave. Before the casting of the intermediate layer with the casting material, this weave determines the defined interspace between the two material layers 1₁ and 2₁.

As can be seen in FIG. 1, the elongated elements 4₁ and 4₂ contact the two material layers 1₁ and 2₁ to be joined at the intersections of the weave in the region 5 and, thus, determine a defined interspace between the two material layers 1₁ and 2₁ before the casting of the casting layer. The height of the interspace, in particular, is defined by the thickness of the elongated elements 4₁ and 4₂ and by the type of weave. In an especially preferred embodiment shown in FIG. 1, the height of the interspace and, thus, the height of the casting or intermediate layer occurs as twice the diameter of the elongated elements 4₁ and 4₂.

Since the elongated elements 4₁ and 4₂ forming the weave do not contact the material layers 1₁ and 2₁ over their entire length, but only in the regions 5, which are separated from one another, the influence of the elongated elements 4₁ and 4₂ on the electrical insulation capabilities and on the thermal conductivity of the composite layer is slight. In addition, adequate flow paths for the casting material are kept free in this way, so that the casting material can fill out the entire space between the elements of the weave without enclosing air bubbles.

In FIGS. 2A and 2B, the weave from FIG. 1 formed by the elongated elements 4₁ and 4₂ is shown in perspective. The elongated elements 4₁ and 4₂ are thereby preferably composed of the known HGW 2372 resin in a fiberglass union (see DIN 7735 and EN 60893 for specifications). As can be seen, the weave formed by the elongated elements 4₁ and 4₂ and shown in FIGS. 2A and 2B form a plain weave.

As especially clear from FIG. 3B, what is understood as a plain weave is a weave wherein differently oriented, elongated elements 4₁ and 4₂ are arranged over or, respectively, under one another in alternation. Deriving therefrom is that both sides of the fabric have an identical weave.

What is especially advantageous about a plain weave is that the regions 5, wherein the elongated elements 4₁ and 4₂ touch the material layers 1₁ and 2₁ to be connected, are extremely small.

Alternatively, however, a twill weave shown in FIG. 3A or an atlas weave shown in FIG. 3C can also be employed for the fabric. It is obvious that the two respective sides of the weave, given the atlas weave as well as the twill weave, are not the same and, therefore, different contact surfaces of the elongated elements 4₁ and 4₂ with the two material layers 1₁ and 2₁, which are to be joined together, occur.

Dependent on the casting material employed, the mesh width of the weave shown in FIG. 2 is selected so that the capillary effect is produced with reference to this casting material. As a result thereof, the casting material is drawn into the casting layer 3 by the weave during casting. Thus, the space 3 between the layer 1₁ and 2₁ is completely filled by the casting material at least in the region wherein the weave formed by the elongated elements 4₁ and 4₂ is arranged.

The elongated elements 4₁ and 4₂ shown in FIGS. 1 and 2 comprise, as shown in FIG. 4A, a circular cross-section. As a result thereof, the area of the regions 5 wherein the elongated elements 4₁ and 4₂ touch the material layers 1₁ and 2₁ to be joined is reduced further. An oval cross-section, or elliptical cross-section, shown in FIG. 4D can also be employed instead of the circular cross-section.

As an alternative, the elongated elements 4₁ and 4₂, however, as shown in FIG. 4B, can comprise a quadratic or rectangular cross-section or even a square cross-section. Such a cross-section is especially advantageous when the elongated elements 4₁ and 4₂ must absorb higher forces in the definition of the interspace between the two material layers 1₁ and 2₁ and the large area of the regions 5, wherein the elongated elements 4₁ and 4₂ touch the material layers 1₁ and 2₁ to be joined can be advantageous.

When, however, a large area of the region 5 wherein the elongated elements 4₁ and 4₂ contact the material layers 1₁ and 2₁, which are to be joined together, is to be avoided, then the elongated elements can, for example, also comprise a polygonal, preferably a triangular, cross-section, such as shown in FIG. 4C.

Given an especially preferred embodiment shown in FIG. 1, the two material layers 1₁ and 2₁, which are to be joined to one another, are gradient coils of a tomograph of a tomograph and, to be more exact, of a nuclear magnetic resonance tomograph. The elongated elements 4₁ and 4₂ are thereby preferably formed of HGW 2372 resin in a fiberglass union. The casting material for the casting layer 3, then, preferably comprises epoxy resin.

Due to the provisions of the mutually crossed, elongated elements 4₁ and 4₂ with different orientations, it is possible in a simple way to define an exact interspace between the two material layers 1₁ and 2₁ before the casting of the casting material for the layer 3. Since the elongated elements 4₁ and 4₂ are also crossed to form a fabric, the elongated elements 4₁ and 4₂ touch the material layers 1₁ and 2 ₁ only at small areas spaced from one another. In addition, the arrangement of the elongated elements 4₁ and 4₂ in a fabric keeps a plurality of flow paths open for the casting material, so that all regions of the interspace between the material layers 1₁ and 2₁ can be filled by the casting material. Consequently, the two material layers 1₁ and 2₁, which are to be connected, can be fixed with great precision relative to one another before the casting without flow paths for the casting material being closed.

While the above-described layer structure has two material layers, such as 1₁ and 2₁, it is, of course, possible that the inventive layer structure can comprise more than two material layers with an intermediate layer between adjacent material layers.

Although various minor modifications may be suggested by those versed in the art, it should be understood that I wish to embody within the scope of the patent granted hereon all such modifications as reasonably and properly come within the scope of my contribution to the art.

I claim:

1. A layer structure comprising at least two material layers which are to be connected together and an intermediate layer between adjacent material layers for joining the adjacent material layers to one another, the intermediate layer comprising a casting material and a plurality of elongated elements having different orientations, said elongated elements being crossed relative to one another and forming a weave that determines the defined interspace between the two material layers before the casting of the material to complete the intermediate layer.

2. A layer structure according to claim 1, wherein the weave extends over the entire casting layer.

3. A layer structure according to claim 1, wherein the length of the elongated elements exceeds the height and width of the elongated elements by at least 20 times.

4. A layer structure according to claim 1, wherein the elongated elements have a circular cross-section.

5. A layer structure according to claim 1, wherein the elongated elements have an elliptical cross-section.

6. A layer structure according to claim 1, wherein the elongated elements have a polygonal cross-section.

7. A layer structure according to claim 1, wherein the elongated elements are woven together in a plain weave.

8. A layer structure according to claim 1, wherein the elongated elements are woven together in a twill weave.

9. A layer structure according to claim 1, wherein the elongated elements are woven together to form an atlas weave.

10. A layer structure according to claim 1, wherein the elongated elements are woven together to form a mesh width that provides a capillary effect with respect to the casting material.

11. A layer structure according to claim 1, wherein the two material layers, which are to be joined together, are gradient coils of a tomograph and the intermediate layer is arranged between the gradient coils.

12. A layer structure according to claim 1, wherein the elongated elements are formed of HGW 2372 resin in a fiberglass union.

13. A layer structure according to claim 12, wherein the casting material for the intermediate layer is an epoxy resin.

14. A layer structure according to claim 1, wherein the casting material for the intermediate layer is an epoxy resin.
